(19) United States
(12) Patent Application Publication
(10) Pub. No.: US 2011/0206097 A1
(43) Pub. Date: Aug. 25, 2011

(54) TERMINALS AND ANTENNA SYSTEMS WITH A PRIMARY RADIATOR LINE CAPACITIVELY EXCITED BY A SECONDARY RADIATOR LINE

(75) Inventor: William H. Darden, IV, Cary, NC (US)

(73) Assignee: Sony Ericsson Mobile Communications AB

(21) Appl. No.: 12/708,596

(22) Filed: Feb. 19, 2010

(51) Int. Cl. H04B 1/38; H01Q 1/38; H01Q 9/04

(52) U.S. Cl. 375/219; 343/700 MS

(57) ABSTRACT

A communications device can include a radiator structure and a transceiver circuit. The radiator structure can include a primary radiator line and a secondary radiator line. The primary radiator line extends from a RF feed node to a distal end and is configured to resonant in at least one RF frequency range. The secondary radiator line extends from the RF feed node to a distal end that is closely spaced to the primary radiator line to provide capacitive excitation at a location along the primary radiator line where at least 70% of a maximum resonant voltage is present in the primary radiator line while resonating. The transceiver circuit is configured to encode data according to one or more communication protocols and to generate a RF signal that is supplied to the RF feed node to cause the radiator structure to radiate the encoded data as RF electromagnetic radiation through a wireless air interface.

### FIELD OF THE INVENTION

The invention generally relates to the field of communications, and more particularly, to antennas that are used by wireless communication terminals for transmission and reception.

### BACKGROUND OF THE INVENTION

Wireless terminals may operate in multiple frequency bands in order to provide operations in multiple communications systems. For example, many cellular radiotelephones, laptop computers, and other electronic communication devices are now designed for pentaband operation in frequency bands that cover, for example, GSM850 (824-894 MHz), GSM900 (880-960 MHz), DCS (1710-1880 MHz), PCS (1850-1990 MHz), and UMTS (1920-2170 MHz).

Achieving effective performance in some or all of the above described frequency bands (i.e., “multiband”) may be difficult. Contemporary wireless terminals are increasingly packing more circuitry and larger displays and keypads/keyboards within small housings. As a consequence, there has been increased use of semi-planar antennas, such as a multi-branch inverted-F antenna, that may occupy a smaller space within a terminal housing. The semi-planar antenna can be printed on/mounted to the terminal's main printed circuit board, but should be placed away from a ground plane of the terminal's printed circuit board to be useful. Constraints on the available space and location for the branches of the antenna can negatively affect the antenna performance.

### SUMMARY

Embodiments according to the invention can provide multiband antennas for use in communications device. In some embodiments, a communications device includes a radiator structure and a transceiver circuit. The radiator structure can include a primary radiator line and a secondary radiator line. The primary radiator line extends from a RF feed node to a distal end and is configured to resonant in at least one RF frequency range. The secondary radiator line extends from the RF feed node to a distal end that is closely spaced to the primary radiator line to provide capacitive excitation at a location along the primary radiator line where at least 70% of a maximum resonant voltage is present in the primary radiator line while resonating. The transceiver circuit is configured to encode data according to one or more communication protocols and to generate a RF signal that is supplied to the RF feed node to cause the radiator structure to radiate the encoded data as RF electromagnetic radiation through a wireless air interface.

In some further embodiments, the communications device further includes a circuit board that includes a conductive ground plane. The first and second radiator lines may conform to a major surface of the printed circuit board and not overlap the conductive ground plane, although the radiator lines may be spaced apart from the printed circuit board on, for example, an antenna carrier structure (e.g., attached to a portion of a terminal housing). The first and second radiator lines may be integrally formed as a single conductive layer on the printed circuit board.

In some further embodiments, the communications device further includes a controller circuit and a display circuit. The transceiver circuitry, the controller circuit, and the display circuit are mounted to the circuit board and are grounded to the ground plane. The first and second radiator lines are spaced apart from the controller circuit and the display circuit.

In some further embodiments, the distal end of the secondary radiator line is closely spaced to the primary radiator line to provide capacitive excitation at a location along the primary radiator line where the maximum resonant voltage is present in the primary radiator line while resonating. The secondary radiator line may extend from the RF feed node to its distal end by a length corresponding to about a quarter wavelength of one of the resonant frequencies. The primary radiator line may extend from the distal end of the primary radiator line to the location where the primary radiator line is capacitively excited by the distal end of the second radiator line by a length corresponding to about a half wavelength of one of the resonant frequencies.

In some further embodiments, the primary radiator line extends a length corresponding to a first fractional value of the wavelength of one of the resonant frequencies from the distal end of the primary radiator line to the location where the primary radiator line is capacitively excited by the distal end of the second radiator line. The secondary radiator line extends from the RF feed node to its distal end by a length that corresponds to a second fractional value of the wavelength of one of the resonant frequencies. The first fractional value is greater than the second fractional value. The first fractional value may be about a half wavelength of one of the resonant frequencies and the second fractional value is about a quarter wavelength of one of the resonant frequencies.

In some further embodiments, the primary radiator line primarily extends from the RF feed node to its distal end in two directions that are perpendicular to each other, and the secondary radiator line primarily extends from the RF feed node to its distal end in two directions that are perpendicular to each other. The primary radiator line may primarily extend from the RF feed node to its distal end in a first direction and then a second direction that are perpendicular to each other, and the secondary radiator line may primarily extend from the RF feed node to its distal end in the second direction and then in the first direction.

In some further embodiments, the primary radiator line and the secondary radiator line are arranged so that a greatest spacing between them occurs at a location along the second radiator line that corresponds to a length corresponding to about an eighth of a wavelength of one of the resonant frequencies from the distal end of the second radiator line.

Some other embodiments are directed to an antenna system that includes a radiator structure. The radiator structure includes a primary radiator line and a secondary radiator line. The primary radiator line extends from a RF feed node to a distal end and is configured to resonant in at least one RF frequency range. The secondary radiator line extends from the RF feed node to a distal end that is closely spaced to the primary radiator line to provide capacitive excitation at a location along the primary radiator line where at least 70% of a maximum resonant voltage is present in the primary radiator line while resonating.

In some further embodiments, the distal end of the secondary radiator line is closely spaced to the primary radiator line to provide capacitive excitation at a location along the primary radiator line where the maximum resonant voltage is present in the primary radiator line while resonating. The secondary radiator line may extend from the RF feed node to its distal end by a length corresponding to about a quarter wavelength of one of the resonant frequencies. The primary radiator line may extend from the distal end of the primary radiator line to the location where the primary radiator line is capacitively excited by the distal end of the second radiator line by a length corresponding to about a half wavelength of one of the resonant frequencies.

In some further embodiments, the primary radiator line extends a length corresponding to a first fractional value of the wavelength of one of the resonant frequencies from the distal end of the primary radiator line to the location where the primary radiator line is capacitively excited by the distal end of the second radiator line. The secondary radiator line extends from the RF feed node to its distal end by a length that corresponds to a second fractional value of the wavelength of one of the resonant frequencies. The first fractional value is greater than the second fractional value. The first fractional value may be about a half wavelength of one of the resonant frequencies and the second fractional value is about a quarter wavelength of one of the resonant frequencies.

In some further embodiments, the primary radiator line primarily extends from the RF feed node to its distal end in two directions that are perpendicular to each other. The secondary radiator line primarily extends from the RF feed node to its distal end in two directions that are perpendicular to each other. The primary radiator line may primarily extend from the RF feed node to its distal end in a first direction and then a second direction that are perpendicular to each other. The secondary radiator line may primarily extend from the RF feed node to its distal end in the second direction and then in the first direction.

In some further embodiments, the primary radiator line and the secondary radiator line are arranged so that a greatest spacing between them occurs at a location along the second radiator line that corresponds to a length corresponding to about an eighth of a wavelength of one of the resonant frequencies from the distal end of the second radiator line.

In some further embodiments, the primary radiator line primarily extends from the RF feed node to its distal end along a curved path, and the secondary radiator line primarily extends from the RF feed node to its distal end along another curved path.

Other antenna systems, communications devices, and/or methods according to embodiments of the invention will be or become apparent to one with skill in the art upon review of the following drawings and detailed description. It is intended that all such additional antenna systems, communications devices, and/or methods be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 illustrates a plan view of a multiband antenna system according to some embodiments of the present invention;

FIG. 2 illustrates a plan view of another multiband antenna system according to some other embodiments of the present invention;

FIG. 3 illustrates a plan view of another multiband antenna system according to some other embodiments of the present invention; and

FIG. 4 is a functional block diagram of a multiband wireless communication terminal with a multiband antenna system that is configured according to some embodiments of the invention.

### DETAILED DESCRIPTION OF EMBODIMENTS ACCORDING TO THE INVENTION

The invention will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, when an element is referred to as being “coupled” to another element, it can be directly coupled to the other element or intervening elements may be present. In contrast, when an element is referred to as being “directly coupled” to another element, there are no intervening elements present. Like numbers refer to like elements throughout.

Spatially relative terms, such as “above”, “below”, “upper”, “lower” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. Well-known functions or constructions may not be described in detail for brevity and/or clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

Embodiments of the invention are described herein with reference to schematic illustrations of idealized embodiments of the invention. As such, variations from the shapes and relative sizes of the illustrations as a result, for example, of manufacturing techniques and/or tolerances, are to be expected. Thus, embodiments of the invention should not be construed as limited to the particular shapes and relative sizes of regions illustrated herein but are to include deviations in shapes and/or relative sizes that result, for example, from different operational constraints and/or from manufacturing constraints. Thus, the elements illustrated in the figures are schematic in nature and their shapes are not intended to illustrate the actual shape of a region of a device and are not intended to limit the scope of the invention.

For purposes of illustration and explanation only, various embodiments of the present invention are described herein in the context of multiband wireless communication terminals (“wireless terminals” or “terminals”) that are configured to carry out cellular communications (e.g., cellular voice and/or data communications) in more than one frequency band. It will be understood, however, that the present invention is not limited to such embodiments and may be embodied generally in any wireless communication terminal that includes a multiband RF antenna that is configured to transmit and receive in two or more frequency bands.

As used herein, the term “multiband” can include, for example, operations in any of the following bands: Advanced Mobile Phone Service (AMPS), ANSI-136, Global Standard for Mobile (GSM) communication, General Packet Radio Service (GPRS), enhanced data rates for GSM evolution (EDGE), DCS, PDC, PCS, code division multiple access (CDMA), wideband-CDMA, CDMA2000, and/or Universal Mobile Telecommunications System (UMTS) frequency bands. GSM operation can include transmission in a frequency range of about 824 MHz to about 849 MHz and reception in a frequency range of about 869 MHz to about 894 MHz. EGSM operation can include transmission in a frequency range of about 880 MHz to about 914 MHz and reception in a frequency range of about 925 MHz to about 960 MHz. DCS operation can include transmission in a frequency range of about 1710 MHz to about 1785 MHz and reception in a frequency range of about 1805 MHz to about 1880 MHz. PDC operation can include transmission in a frequency range of about 893 MHz to about 953 MHz and reception in a frequency range of about 810 MHz to about 885 MHz. PCS operation can include transmission in a frequency range of about 1850 MHz to about 1910 MHz and reception in a frequency range of about 1930 MHz to about 1990 MHz. Other bands can also be used in embodiments according to the invention.

Some embodiments may arise from the present realization that a multiband antenna structure can be configured to use a dual feed excitation structure that excites a primary radiator line using RF signals that are supplied by both by galvanic conduction and by capacitive coupling. The antenna structure may provide improved low band radiator efficiency by supplying RF signals to the primary radiator line using galvanic conduction, and may provide improved high band radiator efficiency by supplying RF signals to the primary radiator line using capacitive coupling.

The antenna structure may include at least a primary radiator line and a secondary radiator line that supplies through capacitive coupling RF excitation signals to the primary radiator line. Some embodiments may further arise from the present realization that the length of the secondary radiator line may preferably be about a quarter wavelength of the desired high band resonance frequency of the primary radiator line. Moreover, the secondary radiator line may preferably be configured to capacitively excite the primary radiator line at a location that is about a half wavelength of one of the resonant frequencies from the distal end of the primary radiator line, which can correspond to where a voltage maximum occurs during resonance of the primary radiator line. A maximum transfer of power may occur when a maximum resonance voltage occurs at both the end of the secondary radiator line that capacitively excites the primary radiator line and at the corresponding location along the primary radiator line that is capacitively excited by the secondary radiator line.

This structural configuration of the primary and secondary radiator lines may provide improved broadband excitation efficiency of the multiband antenna structure across a wider frequency range. For example, this multiband antenna structure may exhibit higher radiation efficiency during transmission and, thereby, have higher Total Radiated Power, lower current drain, and/or increased communication time and/or battery life for a communications device. Similarly, during reception, this multiband antenna structure may provide lower Total Isotropic Sensitivity, which may enable a communication device to maintain an ongoing call further into a fringe area of a base station coverage area and/or deeper into a signal fading environment to avoid dropped calls. Moreover, this multiband antenna structure may enable improved control and localization of high band excitation currents and, thereby, reduced stray currents and fields therefrom and provide improved specific absorption rate (SAR) and/or hearing aid compatibility (HAC).

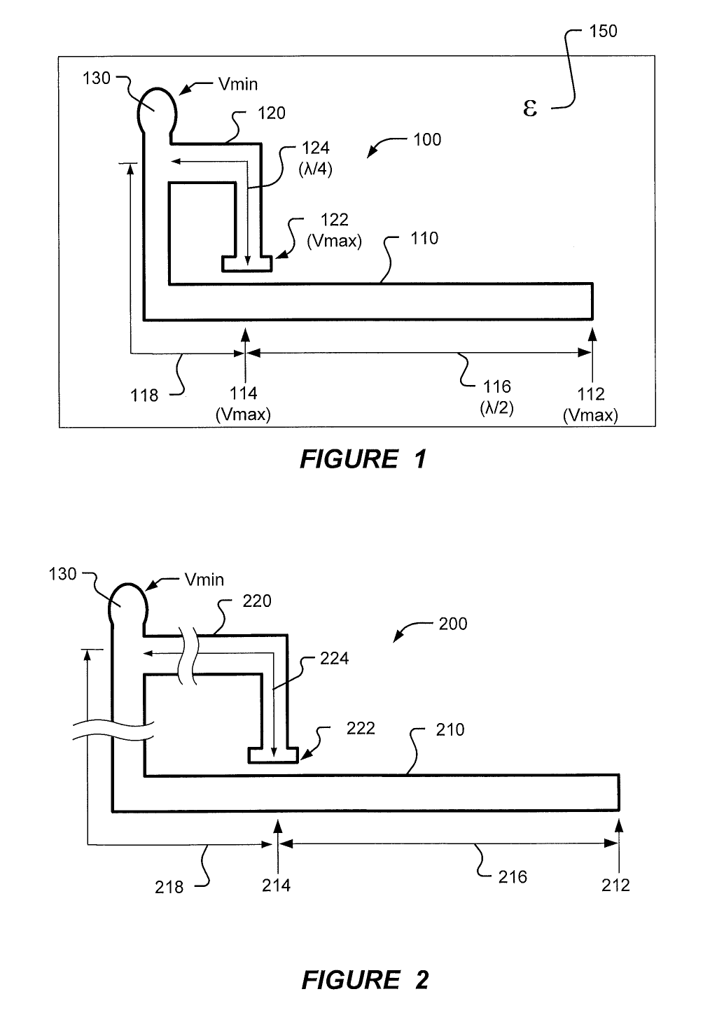

A multiband antenna system that is configured according to some embodiments of the present invention is shown in FIG. 1. Referring to FIG. 1, the antenna system includes a radiator structure 100 that includes a primary radiator line 110 and a secondary radiator line 120. The primary radiator line 110 extends from a RF feed node 130 to a distal end 112 and is configured to be resonated in a plurality of different RF frequency ranges. The secondary radiator line 120 extends from the RF feed node 130 to a distal end 122 that is closely spaced to the primary radiator line 110 to provide capacitive excitation at a location 114 along the primary radiator line 110.

The secondary radiator line 120 is spaced apart from the primary radiator line 110 to reduce capacitive coupling therebetween except from the distal end 122 of the secondary radiator line 120 to the location 114 along the primary radiator line 110. Accordingly, as shown in FIG. 1 in accordance with some exemplary embodiments, the primary radiator line 110 may primarily extend from the RF feed node 130 to its distal end 112 in a first direction and then a second direction that are perpendicular to each other. The secondary radiator line 120 may primarily extend from the RF feed node 130 to its distal end 122 in the second direction and then in the first direction.

The lengths of the primary and secondary radiator lines 110, 120 and the location 114 of the capacitive coupling from the secondary radiator line 120 to the primary radiator line 110 are defined to provide improved broadband excitation efficiency of the multiband antenna structure across one or more desired frequency ranges. In some embodiments, the radiator structure 100 is configured to capacitively excite the primary radiator line 110 at the location 114 where a maximum resonant voltage (Vmax) is present in the primary radiator line 110 during its RF resonance. The distal end 122 of the secondary radiator line 120 may therefore be closely spaced to the primary radiator line 110 at the location 114 where the maximum resonant voltage occurs. The maximum resonant voltage may occur at a length 116 that corresponds to about a half wavelength of one of the resonant frequencies from the distal end 112 of the primary radiator line 110. A length 118 from the capacitive excitation location 114 to the RF feed node 130 can be adjusted to tune the range of resonant frequencies of the primary radiator line 110.

Maximum capacitive excitation may be provided by the secondary radiator line 120 to the primary radiator line 110 when the secondary radiator line 120 has a length 124 that provides a maximum resonant voltage at its distal end 122 that excites the primary radiator line 110. The secondary radiator line 120 can therefore function as a transmission line having a length that can be tuned to maximize its capacitive coupling to the primary radiator line 110. A maximum resonant voltage may occur at the distal end 122 of the secondary radiator line when the length 124 from the RF feed node 130 to the distal end 122 is about a quarter wavelength of one of the resonant frequencies.

Although various efficiencies and advantages are described above may be provided by configuring the secondary radiator line 120 to have a length that corresponds to about a quarter wavelength and the primary radiator line 110 to have a length responding to about a half wavelength from the capacitive coupling location 114 to its distal end 112, the invention is not limited thereto. The primary radiator line 110 has a sinusoidal standing wave excitation waveform and, therefore, the slope is zero at the location of the maximum voltage and initially decreases gradually with distance therefrom and then decreases rapidly further away. Accordingly, the capacitive coupling location 114 can be varied somewhat from the maximum resonant voltage location of the primary radiator line 110 with what may be an acceptable change in transmission/reception efficiency of the radiator structure 110. In view of the roll-off of standing wave voltage in the primary radiator line 110 and the corresponding affect on the transmission/reception efficiency of the radiator structure 100, it has been determined that an acceptable range of transmission/reception efficiency according to some embodiments may be obtained when the primary radiator line 110 is capacitively excited by the secondary radiator line 124 at a location where at least 70% of a maximum resonant voltage is present in the primary radiator line 110 during its RF resonance.

Accordingly, the lengths of the primary and secondary radiator lines 110, 120 and the capacitive coupling location therebetween can be adjusted to provide certain transmission/reception efficiency over a deified range of frequency bands. FIG. 2 illustrates a plan view of another multiband antenna system which illustrates how various lengths of a radiator structure 200 can be adjusted according to some embodiments. Referring to FIG. 2, a primary radiator line 210 may have a length, from its distal end 212 to the capacitive coupling location 214, that corresponds to a first fractional value of the wavelength of one of the resonant frequencies. A secondary radiator line 220 may have a length 224, from the RF feed node 130 to its distal end 222, that corresponds to a second fractional value of the wavelength of one of the resonant frequencies. Because the primary radiator line 210 is configured to be the primary source of RF radiation from the structure 200, the first fractional value should be greater than the second fractional value. The first and second fractional values can be regulated during fabrication to tune the operational frequency ranges (e.g., low and high resonant frequency range) and efficiency of the radiator structure 200.

Although certain advantages, such as maximizing excitation energy, may be provided when the capacitive coupling location 214 corresponds to a location of the maximum resonant voltage in the primary radiator line 210, similar advantages may be obtained when the location 214 corresponds to at least 70% of the maximum resonant voltage in the primary radiator line 210. Similarly, certain advantages may be provided when the secondary radiator line 124 is configured to have a maximum resonant voltage at the distal end 222. For example, similar advantages may be obtained when at least 70% of the maximum resonant voltage in the secondary radiator line 220 occurs at the distal 222.

The radiator structure 100 may be integrally formed on a rigid or flexible dielectric film surface 150, which is illustrated as having a dielectric constant ∈. For example, the radiator structure 100 may be deposited or otherwise formed from a conductive material (e.g. 1 mm width lines) in a pattern on a circuit board that is spaced apart from a ground plane and other circuitry of an electronic device. The primary and secondary radiator lines 110, 120 may be formed from a copper sheet or, alternatively, may be formed from a copper layer that is deposited on a flexible dielectric ribbon that is fixedly connected to and supported by a circuit board and/or various interior surfaces of a housing of the electronic device. It will be understood that antennas according to embodiments of the invention may be formed from other conductive materials and are not limited to copper.

It will be understood by those skilled in the art in view of the present description that the radiator structure 100 may be used for transmitting and/or receiving RF electromagnetic radiation to support communications in multiple frequency bands. In particular, during transmission, the primary radiator line 110 resonates in response to signals received from a transmitter portion of a transceiver and radiates corresponding RF electromagnetic radiation into free-space in corresponding frequency bands. During reception, the primary radiator line 110 resonates responsive to incident RF electromagnetic radiation received via free-space and provides a corresponding signal (in their corresponding frequency band) to the transceiver circuitry. The secondary radiator line 120 may be similarly configured to resonate for transmission and reception of RF signals.

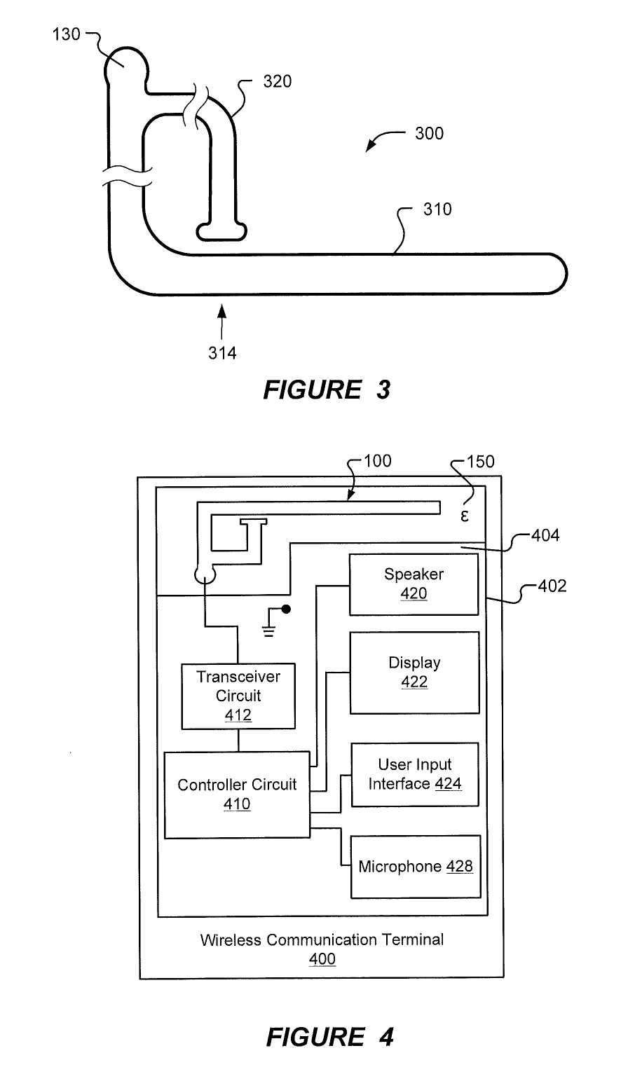

Although the radiator structures 100, 200 in FIGS. 1 and 2 have been shown as having radiator lines that abruptly change direction, the invention is not limited thereto. One or both radiator lines may instead follow curved pathways. For example, FIG. 3 illustrates a plan view of another multiband antenna system in which a radiator structure 300 includes primary and secondary radiator lines 310, 320 that have curved changes in direction. The curved pathways can still provide desired separation between the primary and secondary radiator lines 310, 320 except at the capacitive coupling location 314, and may avoid undesirable spurious RF emissions that can occur along sharp corners of conductive pathways.

FIG. 4 is a functional block diagram of a multiband wireless communication terminal 400 with a multiband antenna system which, for example, may include the radiator structure 100 of FIG. 1, according to some embodiments of the invention. Referring to FIG. 5, the terminal 400 can include a circuit board 402 on which a controller circuit 410, a transceiver circuit 412, a speaker device 420, a display device 422, a user input interface 424 (e.g. keyboard/keypad), and a microphone 428 may be mounted. The circuit board 402 may include a ground plane 404 that provides a common ground circuit for the controller circuit 410, the transceiver circuit 412, the speaker device 120, the display device 422, the user input interface 424 (e.g. keyboard/keypad), and/or the microphone 428.

The radiator structure 100 may be formed directly on a major surface of the circuit board 402 and conform thereto. For example, the primary and second radiator lines 110, 120 may be formed by patterning the same conductive layer that is used to form the ground plane 404, or from a layer that is used to form some other wiring of the circuit board 402. Alternatively, the radiator lines 110, 120 may be on separate layers of a multi-layer structure.

It may be advantageous to position the radiator structure 100 away from the ground plane 404, such as spaced apart on the circuit board 402 from the ground plane 404. A dielectric constant ∈ of a part 150 of the circuit board 402 on which the radiator structure 100 is formed can affect the lengths of the primary and second radiator lines 110, 120 and the associated location along the primary radiator line 110 that is capacitively coupled to the secondary radiator line 120. For example, the RF resonant wavelength of the radiator structure 100 residing on the circuit board 402 may correspond to the RF resonant wavelength in a vacuum divided by the square-root of the dielectric constant ∈ of the part 150 on which the radiator structure 100 is formed.

The controller circuit 410 may include a general purpose processor and/or digital signal processor which can execute instructions from a computer readable memory that carry out at least some functionality to enable wireless communications through the transceiver circuit 412 and the antenna structure 100 to one or more other wireless communication terminals and/or base stations according to one or more RF communication protocols. The controller circuit 410 may functionally operate the speaker 420, the display 422, the user input interface 424, and the microphone 428. The transceiver circuit 412 may be configured to encode/decode and transmit and receive RF communications according to one or more cellular protocols, which may include, but are not limited to, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS), WiMAX, and/or Long Term Evolution (LTE), and/or according to a WLAN (802.11) communication protocol and/or Bluetooth communication protocol, among others.

The transceiver circuit 412 is configured to amplify and supply an electromagnetic radiation signal to the feed node 130 within a selected one of a plurality of different frequency ranges to cause the primary radiator line 110 to resume. The electromagnetic radiation signal from the transceiver circuit 412 may be conducted to the feed node 130 through a coaxial cable, a flex line, and/or a conductive trace on the printed circuit board 402. The transceiver circuit 412 may be further configured to selectively amplify and supply a signal that is received by the primary radiator line 110 from another communication terminal/base station to the controller circuit 410. To facilitate effective performance during transmission and reception, the output/input impedance of the transceiver circuit 412 can be “matched” to an impedance of the antenna structure 100 between the feed node 130 and a ground node to maximize power transfer between the transceiver circuit 412 and the antenna structure 100. It will be understood that, as used herein, the term “matched” includes configurations where the impedances are substantially electrically tuned to compensate for undesired antenna impedance components to provide a particular impedance value.

Many alterations and modifications may be made by those having ordinary skill in the art, given the benefit of present disclosure, without departing from the spirit and scope of the invention. For example, antennas according to embodiments of the invention may have various shapes, configurations, and/or sizes and are not limited to those illustrated. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed:

1. An antenna system comprising:
a radiator structure comprising a primary radiator line and a secondary radiator line, the primary radiator line extends from a RF feed node to a distal end and is configured to resonant in at least one RF frequency range, and the secondary radiator line extends from the RF feed node to a distal end that is closely spaced to the primary radiator line to provide capacitive excitation at a location along the primary radiator line where at least 70% of a maximum resonant voltage is present in the primary radiator line while resonating.

2. The antenna system of claim 1, wherein:
the distal end of the secondary radiator line is closely spaced to the primary radiator line to provide capacitive excitation at a location along the primary radiator line where the maximum resonant voltage is present in the primary radiator line while resonating.

3. The antenna system of claim 2, wherein:
the secondary radiator line extends from the RF feed node to its distal end by a length corresponding to about a quarter wavelength of one of the resonant frequencies; and
the primary radiator line extends from the distal end of the primary radiator line to the location where the primary radiator line is capacitively excited by the distal end of the second radiator line by a length corresponding to about a half wavelength of one of the resonant frequencies.

4. The antenna system of claim 1, wherein:
the primary radiator line extends a first length corresponding to a first fractional value of the wavelength of one of the resonant frequencies from the distal end of the primary radiator line to the location where the primary radiator line is capacitively excited by the distal end of the second radiator line;
the secondary radiator line extends from the RF feed node to its distal end by a second length that corresponds to a second fractional value of the wavelength of one of the resonant frequencies; and
the first fractional value is greater than the second fractional value.

5. The antenna system of claim 4, wherein:
the first fractional value is about a half wavelength of one of the resonant frequencies and the second fractional value is about a quarter wavelength of one of the resonant frequencies.

6. The antenna system of claim 1, wherein:
the primary radiator line primarily extends from the RF feed node to its distal end in two directions that are perpendicular to each other; and
the secondary radiator line primarily extends from the RF feed node to its distal end in two directions that are perpendicular to each other.

7. The antenna system of claim 6, wherein:
the primary radiator line primarily extends from the RF feed node to its distal end in a first direction and then a second direction that is perpendicular to the first direction; and
the secondary radiator line primarily extends from the RF feed node to its distal end in the second direction and then in the first direction.

8. The antenna system of claim 7, wherein:
the primary radiator line and the secondary radiator line are arranged so that a greatest spacing between them occurs at a location along the second radiator line that corresponds to a length corresponding to about an eighth of a wavelength of one of the resonant frequencies from the distal end of the second radiator line.

9. The antenna system of claim 1, wherein:
the primary radiator line primarily extends from the RF feed node to its distal end along a curved path; and
the secondary radiator line primarily extends from the RF feed node to its distal end along another curved path.

10. A communications device comprising:
a radiator structure comprising a primary radiator line and a secondary radiator line, the primary radiator line extends from a RF feed node to a distal end and is configured to resonant in at least one RF frequency range, and a secondary radiator line that extends from the RF feed node to a distal end that is closely spaced to the primary radiator line to provide capacitive excitation at a location along the primary radiator line where at least 70% of a maximum resonant voltage is present in the primary radiator line while resonating; and
a transceiver circuit that is configured to encode data according to one or more communication protocols and to generate a RF signal that is supplied to the RF feed node to cause the radiator structure to radiate the encoded data as RF electromagnetic radiation through a wireless air interface.

11. The communications device of claim 10, further comprising:
a circuit board that includes a conductive ground plane, wherein the first and second radiator lines conform to a major surface of the circuit board and do not overlap the conductive ground plane.

12. The communications device of claim 11, wherein the first and second radiator lines are integrally formed as a single conductive layer on the circuit board.

13. The communications device of claim 10, further comprising:
a controller circuit; and
a display circuit,
wherein the transceiver circuitry, the controller circuit, and the display circuit are mounted to the circuit board and are grounded to the ground plane, and
wherein the first and second radiator lines are spaced apart from the controller circuit and the display circuit.

14. The communications device of claim 10, wherein:
the distal end of the secondary radiator line is closely spaced to the primary radiator line to provide capacitive excitation at a location along the primary radiator line where the maximum resonant voltage is present in the primary radiator line while resonating.

15. The communications device of claim 14, wherein:
the secondary radiator line extends from the RF feed node to its distal end by a length corresponding to about a quarter wavelength of one of the resonant frequencies; and
the primary radiator line extends from the distal end of the primary radiator line to the location where the primary radiator line is capacitively excited by the distal end of the second radiator line by a length corresponding to about a half wavelength of one of the resonant frequencies.

16. The communications device of claim 10, wherein:
the primary radiator line extends a length corresponding to a first fractional value of the wavelength of one of the resonant frequencies from the distal end of the primary radiator line to the location where the primary radiator line is capacitively excited by the distal end of the second radiator line;
the secondary radiator line extends from the RF feed node to its distal end by a length that corresponds to a second fractional value of the wavelength of one of the resonant frequencies; and
the first fractional value is greater than the second fractional value.

17. The communications device of claim 16, wherein:
the first fractional value is about a half wavelength of one of the resonant frequencies and the second fractional value is about a quarter wavelength of one of the resonant frequencies.

18. The communications device of claim 10, wherein:
the primary radiator line primarily extends from the RF feed node to its distal end in two directions that are perpendicular to each other; and
the secondary radiator line primarily extends from the RF feed node to its distal end in two directions that are perpendicular to each other.

19. The communications device of claim 18, wherein:
the primary radiator line primarily extends from the RF feed node to its distal end in a first direction and then a second direction that are perpendicular to each other; and
the secondary radiator line primarily extends from the RF feed node to its distal end in the second direction and then in the first direction.

20. The communications device of claim 19, wherein:
the primary radiator line and the secondary radiator line are arranged so that a greatest spacing between them occurs at a location along the second radiator line that corresponds to a length corresponding to about an eighth of a wavelength of one of the resonant frequencies from the distal end of the second radiator line.
